(19) United States
(12) Patent Application Publication
(10) Pub. No.: US 2026/0134579 A1
(43) Pub. Date: May 14, 2026

(54) PREDICTION SCHEME FOR TRIANGULAR MESHES

(71) Applicant: GOOGLE LLC, Mountian View, CA (US)

(72) Inventor: Igor Vytyaz, Folsom, CA (US)

(21) Appl. No.: 19/359,921

(22) Filed: Oct. 16, 2025

Related U.S. Application Data
(60) Provisional application No. 63/720,448, filed on Nov. 14, 2024.

(51) Int. Cl. G06T 9/00; G06T 9/20

(52) U.S. Cl. CPC G06T 9/001; G06T 9/20

(57) ABSTRACT

Methods and systems for compressing and decompressing vertex data in a triangular mesh may include identifying a first vertex to be decompressed and a plurality of previously decompressed neighboring vertices. A predicted position for the first vertex is determined as a function of adding a first edge vector and a second edge vector to a second vertex among the neighbors, wherein the second vertex is opposite the first vertex. For instance, the neighbors may be located on the perimeter of a hexagon with the first vertex. A received correction variable for the first vertex is then added to the predicted position to obtain the decompressed position of the first vertex. This prediction scheme provides more accurate vertex position predictions, thereby improving compression rates for three-dimensional geometric data. A corresponding method for compression may be used.

### CROSS REFERENCE TO RELATED APPLICATION

This application claims the benefit of U.S. Provisional Application No. 63/720,448, filed November 14, 2024, the disclosure of which is incorporated herein by reference in its entirety.

### BACKGROUND

In three-dimensional systems, digital representations of three-dimensional objects are frequently generated using meshes, which include vertices, edges, and faces that define the shape of an object. One objective when generating these representations is to use as little space as possible for efficient storage and transmission of the three-dimensional data. To achieve this, mesh compression and decompression techniques are employed. These techniques reduce the amount of data required to describe the mesh without significant loss of detail. However, challenges can arise in compressing certain types of meshes, particularly those with irregular or complex topologies, which can limit the effectiveness of standard compression algorithms and necessitate more advanced prediction schemes.

### SUMMARY

Disclosed herein are methods and systems for compressing and decompressing vertex data within a triangular mesh. The present disclosure provides an improved prediction scheme, which may be employed when a target vertex to be processed is located on the perimeter of a hexagon formed by neighboring vertices in the mesh. The improved prediction scheme provides more accurate vertex position predictions, thereby reducing the magnitude of correction data that must be stored or transmitted and achieving higher compression rates for three-dimensional geometric data. The implementations disclosed herein accomplish this by leveraging the regular connectivity of triangular meshes to model local grid curvature, which is an advantage over more generalized prediction schemes.

In one aspect, a method for decompressing a vertex includes identifying a first vertex to be decompressed and a plurality of neighboring, previously decompressed vertices. A predicted position for the first vertex is determined as a function of adding a first edge vector and a second edge vector to a second vertex among the neighbors, where the second vertex is opposite the first vertex on a perimeter of a hexagon. The decompressed position is then obtained by adding a received correction variable to the predicted position. In another aspect, a corresponding method for compressing a vertex involves calculating a predicted position in the same manner based on previously compressed neighboring vertices, determining a correction variable based on the difference between the predicted position and the actual position, and then encoding the first vertex using that correction variable.

The details of one or more implementations are set forth in the accompanying drawings and the description below. Other features will be apparent from the description and drawings, and from the claims.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1A illustrates an encoder/decoder system, according to at least one example implementation.

FIG. 1B illustrates an encoder system, according to at least one example implementation.

FIG. 1C illustrates a decoder system, according to at least one example implementation.

FIGS. 2A and 2B illustrate an example geometric construct in various stages of encoding, according to at least one example implementation

FIGS. 3A and 3B illustrate predicting a position of a next point to encode within a geometric construct, according to at least one example implementation.

FIG. 4 is a block diagram illustrating components of a computing system on which the disclosed implementations may be implemented, according to at least one example implementation.

FIG. 5 is a block diagram of a method for compressing a next vertex within a geometric construct, according to at least one example implementation.

FIG. 6 is a block diagram of a method for decompressing a next vertex within a geometric construct, according to at least one example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Implementations for a prediction scheme for triangular meshes are described herein. Efficient storage and transmission of three-dimensional (3D) data often rely on mesh compression techniques, but standard algorithms struggle with complex or irregular mesh topologies. The implementations disclosed herein address this challenge by providing an improved vertex prediction scheme, which may be referred to as a Hexagon prediction scheme, and is designed for regular triangular mesh connectivity. By exploiting the local grid structure to model curvature more accurately, the disclosed implementations deliver more precise vertex position predictions. This increased accuracy reduces the size of the correction data that needs to be encoded, ultimately resulting in significantly higher compression rates and more efficient handling of 3D geometric data. The implementations disclosed are applicable to various data compression scenarios, including mesh compression and 3D data processing. For instance, in online gaming, smaller 3D model files for characters and environments mean faster loading times and smoother gameplay, as less data needs to be transmitted over the network. In virtual and augmented reality (VR/AR), this allows for more complex and detailed virtual worlds to run efficiently on portable devices like standalone headsets. It could also speed up the loading of 3D product viewers on e-commerce websites, allowing a customer to inspect a pair of shoes or a piece of furniture from all angles almost instantly. The core of this technology is a smarter prediction method that better anticipates the surface shape of a 3D model, reducing the amount of data needed to store or send it.

In modern computing systems, particularly in the field of 3D graphics and modeling, digital representations of physical or virtual objects are important. These 3D representations are often constructed using a polygonal mesh, which is a collection of vertices, edges, and faces that collectively define the shape and surface of an object. The efficiency of storing and transmitting these 3D models is important, as uncompressed mesh data can consume significant memory and bandwidth resources. Consequently, the use of mesh compression techniques is important in reducing the data footprint of these models, thus enabling faster transmission over networks and more efficient storage on various media. Effective compression is particularly important in improving applications such as virtual and augmented reality, online gaming, and scientific visualization, where large and complex 3D models are often handled in real-time. For these applications, it is important to generate digital representations as fast as possible (considering processing power and situational timelines). It is also advantageous to minimize code complexity (e.g., to affect the processing time).

A common and versatile type of polygonal mesh is the triangular mesh, where all faces are triangles. The regular and predictable structure of triangular meshes lends itself to various compression strategies. However, achieving high compression rates for triangular meshes presents a significant technical problem. Some advanced compression algorithms rely on predictive coding, where the position of a vertex is predicted based on the positions of its already-processed neighbors. The actual position is then encoded by storing only a correction variable, which is a vector representing the difference between the predicted and actual positions and may also be referred to as a correction vector. The accuracy of the prediction scheme is therefore directly correlated with the compression efficiency. That is, a more accurate prediction results in a smaller correction vector, which requires fewer bits to store, thereby improving the compression rate. One technical problem with existing methods is that achieving highly accurate predictions, especially for meshes with complex curvatures or irregular connectivity, remains a challenge.

Existing prediction schemes for triangular meshes often face a technical problem in that they are too generalized and fail to take full advantage of the specific local topology of the mesh. For instance, many conventional methods use a small neighborhood of vertices immediately adjacent to the target vertex to formulate a prediction. While simple and broadly applicable, this approach presents a technical problem because it often fails to capture higher-order surface characteristics, such as local grid curvature and the spacing of grid lines. This limitation leads to less accurate predictions and, consequently, lower compression rates than what is theoretically possible. Another technical problem arises from the fact that these simpler predictors do not adequately model how patterns and curvatures propagate across the mesh, resulting in systematically larger correction vectors. There is, therefore, a persistent technical problem and a need in the field for more sophisticated prediction schemes that can leverage the specific structural properties of common mesh connectivities to deliver more accurate vertex position predictions and improve overall compression performance.

To address the aforementioned technical problems, this disclosure provides a novel technical solution in the form of an improved prediction scheme specifically designed for triangular meshes that exhibit regular or semi-regular connectivity. Conventional solutions, such as generic parallelogram prediction, often fall short because they do not account for the specific hexagonal patterns that frequently emerge in regular triangular meshes (e.g., triangular grids), where a central vertex is surrounded by six neighbors. These methods are inadequate because they overlook the valuable geometric information inherent in this common structural arrangement. The failure of prior systems to exploit this specific topology represents a missed opportunity for achieving higher prediction accuracy and, by extension, better compression.

The technical solutions described herein provide a compression scheme for when a target vertex to be encoded or decoded is situated on the perimeter of a hexagon formed by six neighboring vertices that all share a common central neighbor. Put another way, neighboring vertices share at least one common polygonal face with a specified vertex (common central neighbor) in a polygonal mesh. The technical solution involves calculating a predicted position for this target vertex by using the positions of the other five vertices on the hexagon's perimeter. The five positions are known because they have been previously processed. Specifically, the prediction is a function of adding two edge vectors, derived from pairs of the known vertices, to the vertex on the hexagon's perimeter that is directly opposite the target vertex. In an ordered sequence of six vertices forming a hexagonal perimeter, the vertex that is three positions away from the first vertex in the sequence is the vertex opposite the target vertex. This technique effectively models the local grid curvature by extrapolating the known geometry of the surrounding neighborhood.

This approach offers a more refined and context-aware technical solution compared to conventional methods. By using a larger and more structured neighborhood of five known vertices arranged in a hexagonal pattern, the technical solution can capture subtle variations in the mesh surface that simpler predictors would miss. The formulation of the prediction, t = c + (a – b) + (e – d), where t is the target vertex, c is the opposite vertex, and a, b, d, and e are the other known neighbors, is a technical solution that effectively incorporates information about the curvature and spacing of the local grid lines. This formulation constitutes a specific, concrete algorithm for transforming 3D mesh data inextricably tied to the technological context of the triangular mesh data structure. This formulation allows the system to make a more informed and accurate prediction of the target vertex's position, thereby solving the technical problem of insufficient prediction accuracy in prior systems. This results in a smaller size correction value needed for arriving at the actual position of the target vertex which improves the compression rate.

The disclosed implementations provide several advantageous technical effects. A primary technical effect is a significant improvement in compression rates for 3D triangular meshes. By providing more accurate vertex position predictions, the magnitude of the required correction vectors is substantially reduced. Smaller correction vectors can be encoded using fewer bits, leading to a direct and measurable reduction in the overall file size of the compressed mesh. This technical effect is particularly pronounced in meshes with regular connectivity and high-precision vertex coordinates, where the Hexagon prediction scheme can consistently outperform state-of-the-art predictors.

At least one other technical effect of the disclosed prediction scheme is taking advantage of common regular mesh connectivities, where each vertex is connected to six edges, which enables the disclosed techniques to capture higher order effects like triangular mesh curvature. This delivers more accurate predictions and higher compression rates compared to the best prediction schemes available for triangular meshes.

Another technical effect is the increased efficiency in the storage and transmission of 3D data. By achieving higher compression rates, the same amount of storage space can hold more 3D models, and these models can be transmitted over networks more quickly and with lower bandwidth consumption. This is an important technical effect for applications that rely on the rapid exchange of 3D assets, such as collaborative design platforms, cloud-based rendering services, and real-time multiplayer games. Furthermore, because the prediction logic for both compression and decompression is identical, the process remains computationally efficient, ensuring that the benefits of higher compression do not come at the cost of excessive processing overhead. Ultimately, the technical solution yields the technical effect of a more robust and powerful mesh compression framework.

The Hexagon prediction scheme is broadly applicable to any field that involves the processing, storage, and transmission of 3D triangular meshes. In the domain of virtual and augmented reality (VR/AR), the implementations discussed herein may be used to compress 3D assets, such as virtual environments and character models, allowing them to be loaded more quickly and consume less memory on resource-constrained devices such as head-wearable displays. Similarly, in online gaming, faster transmission of smaller 3D model files translates to reduced latency and smoother gameplay experiences, particularly in multiplayer scenarios where geometric data is frequently exchanged between clients and servers. The techniques are also valuable for cloud-based 3D modeling and rendering platforms, where efficient transfer of complex mesh data to and from remote servers is important for interactive performance.

Furthermore, the implementations disclosed herein find practical application in scientific and medical visualization, where high-precision geometric models representing datasets from simulations or medical scans (e.g., MRI, CT) need to be stored and shared efficiently. By improving compression rates for these often large and detailed meshes, the disclosed implementations facilitate easier data archiving and faster collaboration among researchers and practitioners. The scheme could be integrated into existing and future 3D graphics compression standards and libraries, making it a valuable component in the broader ecosystem of 3D data handling across various industries. Any application that benefits from smaller file sizes and lower bandwidth usage for 3D triangular meshes can leverage the technical solution.

The term “vertex” as used herein may refer to a building block of a geometric construct such as a mesh. In an example, a vertex refers to a point in a 3D space that is defined by its coordinates, which may be an (x, y, z) value. As such, a vertex may provide the spatial position for a specific point on the surface of a 3D model. Moreover, beyond position, a vertex may store other important data such as color, normal vectors, texture data, and the like.

Vertices are often connected to each other by edges to form polygons such as triangles. The polygons collectively form a mesh that defines an object’s shape and/or surface. An edge is a connection (e.g., a straight line) between two vertices within a geometric mesh. In the context of mesh compression and prediction schemes, an edge is often represented as a vector derived from the positions of the two vertices it connects. For example, the edge from vertex d to vertex e can be represented by the vector e - d. The edge vectors may be used to describe the mesh's connectivity and to model grid line curvature and spacing to predict the position of other vertices.

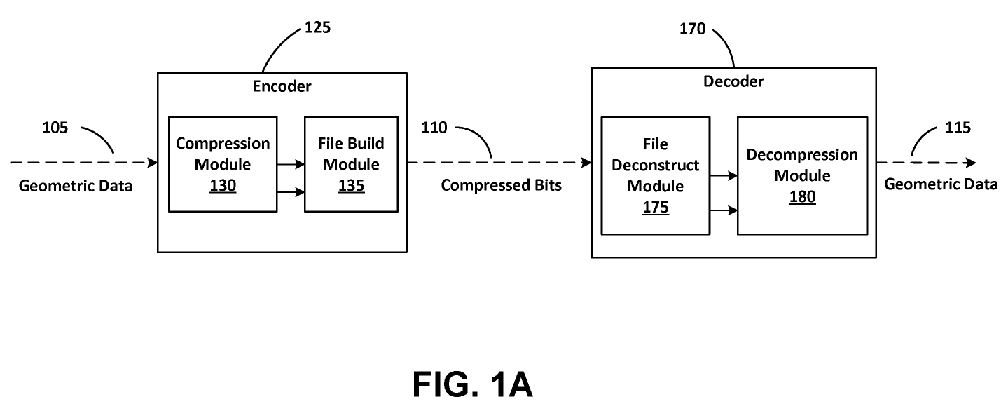

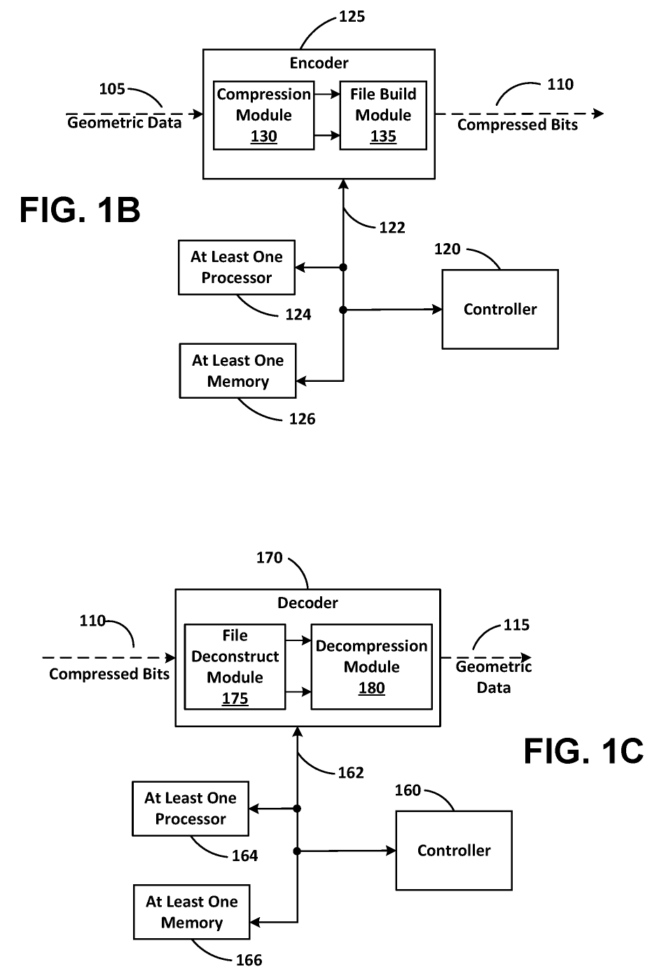

FIG. 1A illustrates an encoder/decoder system according to at least one example implementation. As shown in FIG. 1A, the encoder/decoder system can include an encoder 125 and a decoder 170. The encoder 125 can include a compression module 130 and a file build module 135. The decoder 170 can include a file deconstruct module 175 and a decompression module 180. The encoder 125 can be configured to generate compressed bits 110 based on geometric data 105. The decoder 170 can be configured to generate geometric data 115 based on compressed bits 110. Geometric data 115 can be reconstructed geometric data corresponding to (representing, associated with, and the like) geometric data 105.

The compression module 130 can be configured to compress geometric data using a prediction scheme configured to predict vertices in a triangular mesh. For example, compression module 130 may include a memory configured to store a plurality of compression schemes. At least one of the compression schemes can include a prediction scheme configured to predict vertices in a triangular mesh. In some implementations, the compression scheme is used for vertices in a triangular mesh where the vertex satisfies two criteria. The first criterion is that the vertex is on the perimeter of a hexagon. The hexagon is formed around a center vertex, which is connected to each of the vertices on the perimeter of the hexagon. The second criterion is that the other five vertices on the perimeter have previously been visited. A visited vertex is a vertex for which the position has been already encoded (if the process is part of encoding by the encoder 125) or decoded (if the process is part of decoding by the decoder 170). Other prediction schemes can be used where the criteria for the Hexagon prediction scheme are not met. A starting vertex in a mesh may have no prediction scheme applied.

The compression module 130 can be configured to communicate a compressed mesh and an indication of the compression scheme and/or the prediction scheme used on each vertex to the file build module 135. The file build module 135 generates a file based on a plurality of entropy encoded values representing compressed geometric data 105 and the compression scheme and/or the prediction scheme used to compress the geometric data 105. The generated file may include a header or other metadata including information about the geometric construct (e.g., point cloud, mesh, and the like), the compression scheme and/or the prediction scheme (e.g., variables associated with the compression module 130), and the like. The generated file may be stored in a local memory of the file build module 135 or encoder 125, and/or the generated file may be communicated to another device (e.g., a device separate from and communicatively coupled to the device that encoded the geometric construct) as the compressed bits 110.

The file deconstruct module 175 of the decoder 170 may receive a file that includes the compressed bits 110. The compressed bits may represent a stream of data corresponding to a geometric construct (e.g., point cloud, mesh, and the like). The compressed bits 110 were previously compressed using a prediction scheme configured to predict vertices in a triangular mesh(es). The file deconstruct module 175 may determine the prediction schemes used to compress the geometric construct and a plurality of entropy encoded values representing compressed geometric data 105. The file deconstruct module 175 can be configured to communicate the prediction schemes and the plurality of entropy encoded values representing compressed geometric data 105 to the decompression module 180. The decompression module 180 may then decompress the plurality of entropy encoded values representing compressed geometric data 105 using the prediction schemes. The decompressed data can be geometric data 115 or reconstructed geometric data corresponding to (representing, associated with, and the like) geometric data 105.

FIG. 1B illustrates an encoder system, according to at least one example implementation. In the example of FIG. 1B, an encoder system may be at least one computing device and should be understood to represent any computing device configured to perform the methods described herein. As such, the encoder system constitutes a special-purpose computing device, and its standard hardware components are specially configured by computer-executable instructions to implement the techniques described herein, or different or future versions thereof, thereby transforming what would be a general-purpose computer into a specialized and more efficient machine for 3D mesh compression. By way of example, the encoder system is illustrated as including at least one processor 124, as well as at least one memory 126 (e.g., a non-transitory computer-readable storage medium).

The at least one processor 124 may be utilized to execute instructions stored on the at least one memory 126 to implement the various features and functions described herein, or additional or alternative features and functions. Furthermore, the at least one processor 124 and the at least one memory 126 may be utilized for various other purposes. In particular, the at least one memory 126 may be understood to represent an example of various types of memory and related hardware and software which might be used to implement any one of the modules described herein.

As shown in FIG. 1B, the encoder system includes the processor 124, the memory 126, a controller 120, and an encoder 125. The processor 124, the memory 126, the controller 120, and the encoder 125 are communicatively coupled via a bus 122.

The processor 124 may be configured to execute computer instructions associated with the controller 120 and/or the encoder 125. Moreover, the processor 124 may be a shared resource. For example, the encoder 125 may be an element of a larger system (e.g., a 2D or 3D scanner). Therefore, the processor 124 may be configured to execute computer instructions associated with other elements (e.g., controller laser scanner position or movement) within the larger system.

The memory 126 may be configured to store data and/or information associated with the encoder 125. For example, the memory 126 may be configured to store buffers including, for example, buffers storing geometric data, portions of the geometric data, positions of data points in the geometric data, a number of data points associated with a portion of the geometric data, and/or the like. For example, the one memory 126 may be configured to store buffers including, for example, data associated with a geometric construct such as a mesh, a point cloud, and the like.

The controller 120 may be configured to generate various control signals and communicate the control signals to various blocks in the encoder 125. The controller 120 may be configured to generate the control signals in accordance with the methods described above. The controller 120 may be configured to control the encoder 125 to encode data associated with a geometric construct according to example implementations as described herein. For example, the controller 120 may generate and communicate a control signal indicating a compression scheme in compression module 130. For example, the controller 120 may generate and communicate a control signal indicating the prediction scheme configured to predict vertices in a triangular mesh(es).

FIG. 1C illustrates a decoder system, according to at least one example implementation. In the example of FIG. 1C, a decoder system may be at least one computing device and should be understood to represent any computing device configured to perform the methods described herein. As such, the decoder 170 may be understood to include various standard components which may be utilized to implement the techniques described herein, or different or future versions thereof. By way of example, the decoder 170 is illustrated as including at least one processor 164, as well as at least one memory 166 (e.g., a non-transitory computer-readable storage medium).

As shown in FIG. 1C, the decoder system includes the at least one processor 164, the at least one memory 166, a controller 160, and a decoder 170. The processor 164, the memory 166, the controller 160, and the decoder 170 are communicatively coupled via a bus 162.

The processor 164 may be utilized to execute instructions stored on the memory 166 to thereby implement the various features and functions described herein, or additional or alternative features and functions. Additionally, the processor 164 and the memory 166 may be utilized for various other purposes. In particular, the memory 166 may be understood to represent an example of various types of memory and related hardware and software which might be used to implement any one of the modules described herein. According to example implementations, the encoder system of FIG. 1B and the decoder system FIG. 1C may be included in the same larger system. Further, the processor 164 and the processor 124 may be the same processor and the memory 166 and the 126 may be the same memory. Still further, the controller 160 and the controller 120 may be the same controller.

The processor 164 may be configured to execute computer instructions associated with the controller 160 and/or the decoder 170. The processor 164 may be a shared resource. For example, the decoder system may be an element of a larger system (e.g., a mobile device). Therefore, the processor 164 may be configured to execute computer instructions associated with other elements (e.g., web browsing or wireless communication) within the larger system.

The memory 166 may be configured to store data and/or information associated with the decoder system. For example, the memory 166 may be configured to store buffers including, for example, buffers storing geometric data, portions of the geometric data, positions of data points in the geometric data, a number of data points associated with a portion of the geometric data, and/or the like. For example, the memory 166 may be configured to store buffers including, for example, data associated with a geometric construct.

The controller 160 may be configured to generate various control signals and communicate the control signals to various blocks in the decoder system. The controller 160 may be configured to generate the control signals in accordance with the methods described above. The controller 160 may be configured to control the decoder 170 to decode data associated with a geometric construct according to example implementations as described above. For example, the controller 160 may generate and communicate a control signal indicating a prediction scheme configured to predict vertices in a triangular mesh(es) using a Hexagon prediction scheme.

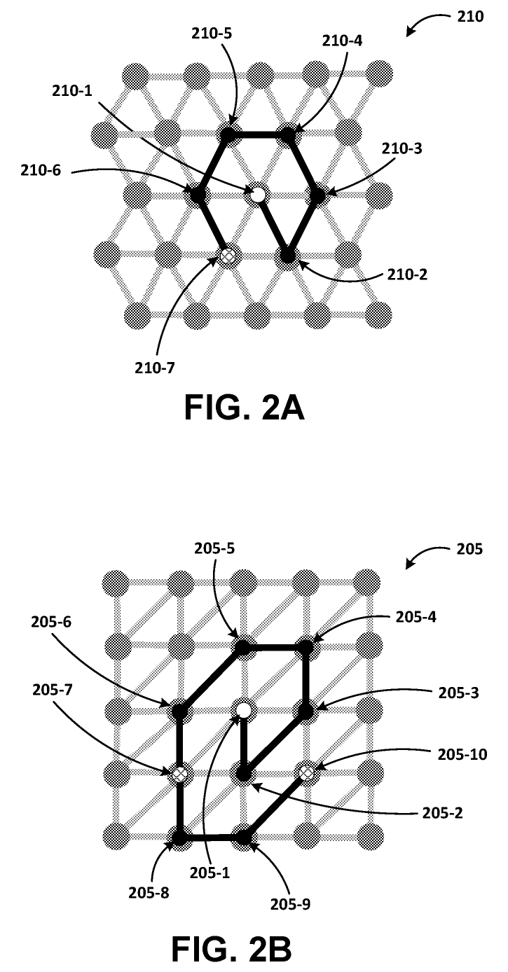

FIGS. 2A and 2B illustrate an example geometric construct in various stages of encoding, according to at least one example implementation. FIG. 2A illustrates a geometric construct 210 as an example triangular mesh. A geometric construct is a data structure that represents the geometry of a three-dimensional object, wherein the data structure includes positional coordinates for a set of points that define the object's surface or volume. A geometric construct such as the geometric construct 210 may be a mesh, a point cloud, and the like. In a triangular mesh (or grid), each vertex may be connected to six edges. Vertices on an edge of the mesh can be connected to less than six edges.

In FIG. 2A, a compression algorithm has begun to compress some vertices of the geometric construct 210. The compression algorithm traverses the grid compressing vertices along the traversal path. In the example of FIG. 2A, the traversal path is a spiraling vertex traversal, but the Hexagon prediction scheme may be used with various traversal paths, and is not limited to the spiraling vertex traversal shown. In the example of FIG. 2A, the traversal path started at vertex 210-1, and has visited vertex 210-2, vertex 210-3, vertex 210-4, vertex 210-5, and 210-6. None of these vertices were eligible for the application of the Hexagon prediction scheme because none were in the perimeter of a hexagon where the other five vertices in the perimeter were already visited. Therefore, the compression algorithm has encoded the vertices (210-1 to 210-6) using another prediction method.

FIG. 2B illustrates a geometric construct 205 (e.g., a mesh, a point cloud, and the like) as a triangulated quad mesh. In the example of FIG. 2B, some vertices have been compressed using a spiraling vertex traversal starting from vertex 205-1. The compression algorithm has traversed the geometric construct 205 from vertex 205-1, visiting vertex 205-2, vertex 205-3, vertex 205-4, vertex 205-5, vertex 205-6, vertex 205-7, vertex 205-8, and vertex 205-9. Thus, each of these vertices has been encoded (compressed) by the compression algorithm. Because of meeting the criteria, vertex 205-7 is eligible for the Hexagon prediction scheme, and any prediction scheme could have been used to compress vertex 205-2, vertex 205-3, vertex 205-4, vertex 205-5, vertex 205-6, vertex 205-7, vertex 205-8, and vertex 205-9. In the example of FIG. 2B, vertex 205-10 is the target vertex (the one being encoded). Vertex 205-10 is eligible for the Hexagon prediction scheme because it is on the perimeter of a hexagon (which has vertex 205-2 at its center) and the other five vertices in the perimeter (e.g., vertex 205-3, vertex 205-1, vertex 205-7, vertex 205-8, and vertex 205-9) have already been visited. Thus, the compression algorithm can use the Hexagon prediction scheme to encode vertex 205-10.

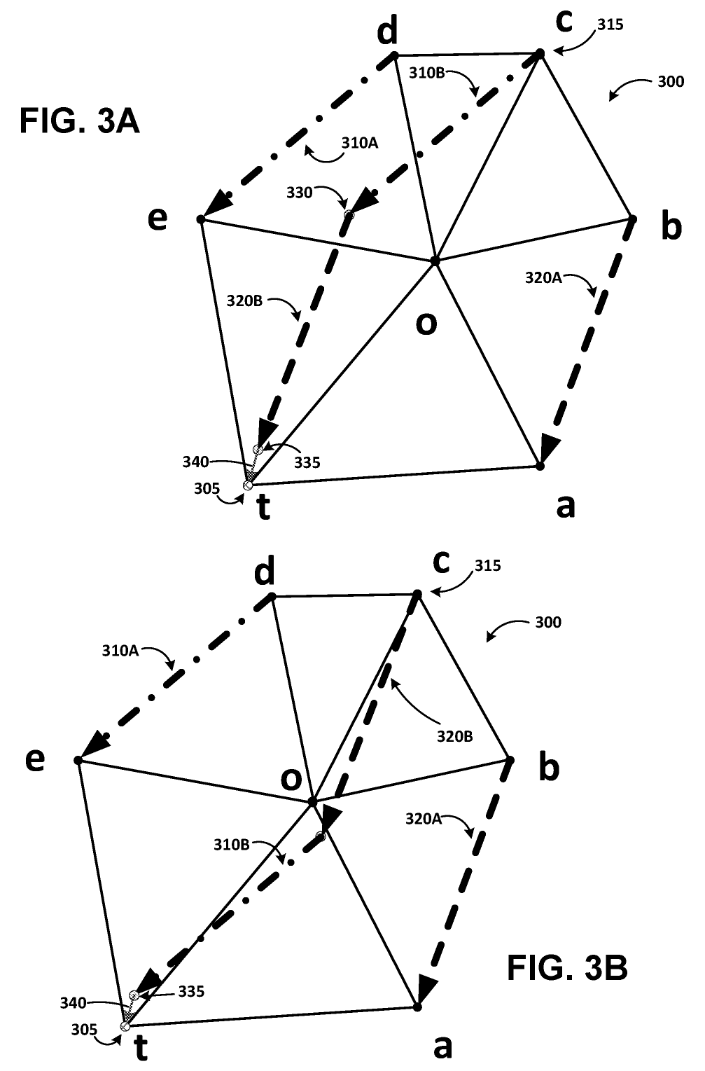

Upon reaching vertex 210-7 in the traversal, the encoder can determine that vertex 210-7 meets two criteria, the first is that vertex 210-7 is on the perimeter of a hexagon and the second criteria is that the other five vertices (210-2, 210-3, 210-4, 210-5, and 210-6) of the hexagon have been visited. The hexagon surrounds vertex 210-1, which is a neighbor shared by all the vertices on the perimeter. Because the positions of five vertices have been already encoded, the Hexagon prediction scheme can use the positions of the other five vertices to predict a position of the current vertex, vertex 210-7, as described below with respect to FIGS. 3A and 3B.

FIGS. 3A and 3B illustrate predicting a position of a next point to encode within a geometric construct, according to at least one example implementation. FIGS. 3A and 3B are used to illustrate a Hexagon prediction scheme on a grouping 300 of seven vertices (a, b, c, d, e, t, and o) in a triangular mesh. In the example of FIGS. 3A and 3B, the vertex labeled t is the target vertex, or in other words, the currently visited vertex or the vertex being encoded or decoded. The vertices labeled a, b, c, d, and e are on the perimeter of the hexagon formed by the grouping 300. The vertices labeled a, b, c, d, and e are considered neighborhood vertices of t. In the example of FIGS. 3A and 3B, vertices a, b, c, d, and e have been visited. Thus, the Hexagon prediction scheme is available for vertex t because the vertex t is on a perimeter of a hexagon and the five other vertices on the perimeter have already been visited. The vertex o is not used as part of the Hexagon prediction scheme but is considered a common central neighbor shared by the vertices on the perimeter of the hexagon. In the disclosed prediction scheme, the other five vertices on the shared perimeter are used to predict a position for vertex t. The predicted position 335 can be the actual position 305 of vertex t, but in most cases it is not. Thus, a difference, represented by vector 340, may be calculated for vertex t. The difference represents a vector from the predicted position 335 to the actual position 305.

To obtain the predicted position 335, a vector 310A representing the edge from vertex d to vertex e and a vector 320A representing the edge from vertex b to vertex a is used. That is because, as depicted in FIG. 3A, the vectors 310A and 310B are the same size. Similarly, the vectors 320A and 320B are the same size. As a result, adding the vectors 310A and 320A to the vertex c which is located opposite of the vertex t in the perimeter results in a predicted position 335 for the vertex t. The predicted position of vertex t can be represented as t = c + (a – b) + (e – d).

In the example of FIG. 3A, starting from vertex c, at position 315, the vector 310A (e.g., e - d), which is equal in size to vector 310B is added to vertex c. This results in arriving at a position 330. Then, the vector 320A (e.g., a - b) which is equal to the vector 320B is added to the position 330, to arrive at the predicted position 335. Predicted position 335 is not the actual position 305. However, it is very close to the actual position 305. To determine the actual position 305, a vector 340 which is determined to represent the offset from the predicted position 335 to the actual position 305 is calculated. This can be achieved while performing compression, because the actual position of the vertex t is known. However, instead of storing and transmitting the actual position, the value of the offset vector 340 can be stored as part of the compression of vertex t. This results in a significant reduction in the size of the data needed to determine the position of the vertex t.

In the example of FIG. 3B, starting from vertex c, the vector 320A (e.g., a - b) is added to vertex c, and then the vector 310A (e.g., e - d) is added, arriving at predicted position 335. Predicted position 335 is not the actual position 305. As such, a vector 340 is determined to represent the offset from the predicted position 335 to the actual position 305. This offset may be stored as part of the compression of vertex t. A and 3B illustrate that the vectors 310A and 320A can be to the vertex opposite of the target vector in the perimeter of the hexagon to arrive at the predicted position, as vectors 310A and 310B and 320A and 20B represent the same distance.

Some of these implementations can provide various technical advantages such as enhanced computational efficiency, which is particularly beneficial for resource-constrained devices. Furthermore, the prediction scheme can be implemented using bitwise integer operations, leading to faster execution times and reduced power consumption on devices like embedded processors or GPUs. The simplicity of the underlying mathematical operations (t = c + (a – b) + (e – d)) results in a low code complexity, which facilitates easier integration into existing compression libraries and standards, while also minimizing the risk of implementation errors.

The Hexagon prediction scheme is particularly effective for large, regular triangular meshes due to its high applicability rate. As a compression or decompression algorithm traverses a triangular mesh, for example one with a radius of n vertices, the number of vertices that meet the criteria for the Hexagon prediction grows quadratically, at a rate proportional to O(n²). In contrast, the number of vertices for which the prediction is unavailable, typically those near the initial traversal path or the mesh boundary, grows only linearly, at a rate proportional to O(n). This scaling advantage ensures that the Hexagon prediction scheme can be applied to a majority of vertices in large-scale meshes, making it a highly efficient and broadly applicable method for improving compression performance across a wide range of 3D models.

In some implementations, the accuracy of the Hexagon prediction scheme is dependent upon the quality of the underlying vertex data. Specifically, the predictor achieves higher accuracy when the vertex values possess a strong geometric signal relative to the amount of quantization noise. When processing vertex data that has been aggressively quantized, the geometric signal may be diminished, and the quantization noise becomes more prominent. In such scenarios, the Hexagon prediction scheme, which relies on extrapolating geometric patterns from edge vectors, can inadvertently amplify this noise. This amplification leads to less accurate predictions, larger correction vectors, and consequently, a lower overall compression rate.

In some implementations, to mitigate this effect and optimize compression performance, a more adaptive strategy may be employed. This may involve using more generalized prediction schemes when noise is high. When quantization noise is high, falling back to simpler, more generalized prediction schemes can prove more effective than forcing the use of the Hexagon prediction scheme. A practical approach to implementing this is to restrict the application of the Hexagon prediction scheme to cases where the geometric signal is sufficiently strong. This can be accomplished by setting a criterion (e.g., a threshold) based on the magnitude of the known edge vectors involved in the prediction. For instance, the system could require that the L1 norm of the relevant hexagon edge vectors exceed a predefined value, such as 50 quantization steps, ensuring the predictor is only used when the geometric data is robust enough to yield a reliable and beneficial prediction.

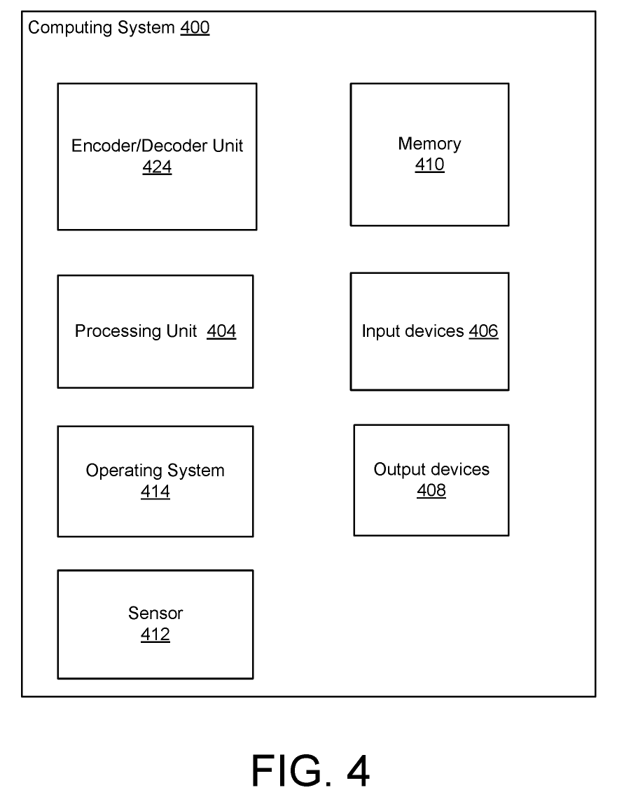

FIG. 4 is a block diagram illustrating components of a computing system on which the disclosed implementations may be implemented, according to at least one example implementation. In general, the computing system 400 can represent any computing device that can be configured to execute operations of a system such as the encoder 125 or the decoder 170 of FIG. 1A, to encode and/or decode a mesh using the implementations disclosed herein. Although not all shown in FIG. 4, the computing system 400 may include several hardware components including a communication module (not shown), a memory 410, a processing unit 404, such as a central processing unit (CPU), a neural processing unit (NPU) and/or a graphics processing unit (GPU), one or more input devices 406 (e.g., touch screen, mouse, stylus, microphone, keyboard, etc.), one or more output devices 408 (screen, display, speaker, vibrator, light emitter, etc.), and an operating system 414. The hardware components can be used to facilitate operation of the encoder/decoder unit 424, and/or other applications of the computing system 400. For example, elements of the encoder/decoder unit 424 can be stored on the memory 410, and the encoder/decoder unit 424 may be executed by the processing unit 404 (e.g., an NPU or CPU).

The sensor 412 may include a sensor such as a camera for capturing images or videos such as 3D images and/or videos which may be used to generate geometric data, which can then be encoded and/or decoded using the encoder/decoder unit 424. In some implementations, the geometric data encoded and/or decoded by the encoder/decoder unit 424 is captured in a different manner and/or is received from a different device. The memory 410 may represent any kind of (or multiple kinds of) memory (e.g., RAM, flash, cache, disk, tape, etc.). In some examples (not shown), the memory 410 may include external storage, e.g., memory physically remote from but accessible by the computing system 400. The memory 410 can be a semiconductor-based memory.

The processing unit 404 may be a semiconductor-based processor. Each of the components 404, 406, 408, 410, 412 and 414, are interconnected using various busses, and may be mounted on a common motherboard or in other manners as appropriate. The processing unit 404 can process instructions for execution within the computing system 400, including instructions stored in the memory 410. In other implementations, multiple processors and/or multiple buses may be used, as appropriate, along with multiple memories and types of memory.

The operating system 414 is a system software that manages computer hardware and software resources, and provides common services for computing programs. In some examples, the operating system 414 is operable to run on a computing device such as a device used to encode and/or decode geometric data. The operating system 414 may include a plurality of modules that enable the operations of the computing system 400.

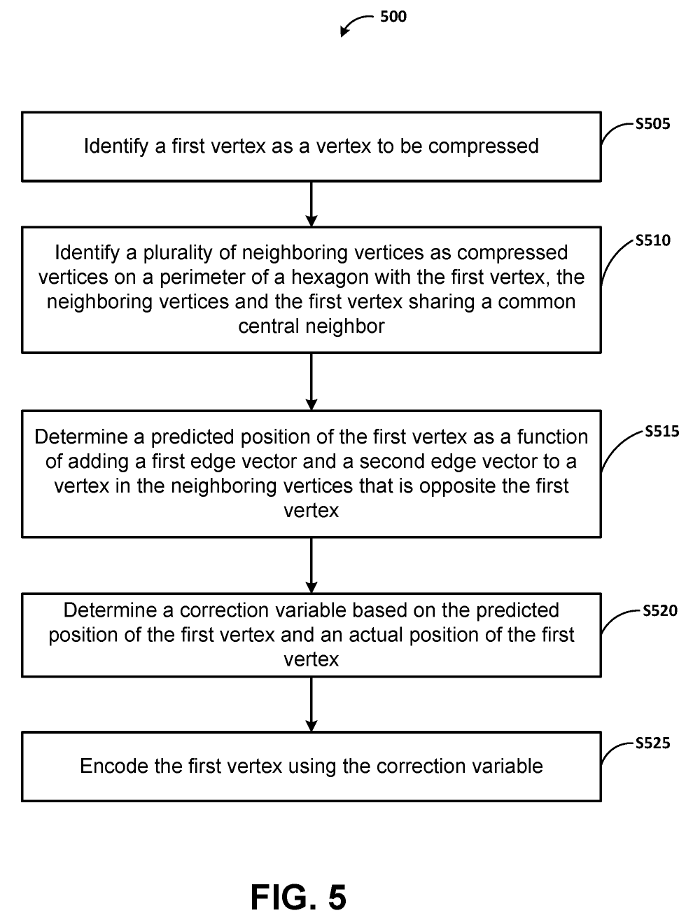

FIG. 5 is a block diagram of a method 500 for compressing a next vertex within a geometric construct according to at least one example implementation. The method 500 may be used on any vertex in a geometric construct such as a triangular mesh (e.g., mesh, grid, point cloud, and the like) that satisfies two criteria. The first criterion is that the vertex (e.g., the first vertex) is on a perimeter of a hexagon formed by the grid. The second criterion is that the other vertices in the perimeter have been previously visited.

As shown in FIG. 5, in step S505 an encoder may identify a first vertex as a vertex to be compressed. This may occur during an encoding operation. In step S510 the encoder may identify a plurality of neighboring vertices as compressed vertices on a perimeter of a hexagon with the first vertex, the neighboring vertices and the first vertex sharing a common central neighbor. This ensures that the vertex satisfies both criteria of being on a perimeter of a hexagon and having neighboring vertices that have already been visited.

In step S515 the encoder may determine a predicted position of the first vertex as a function of adding a first edge vector and a second edge vector to a vertex in the neighboring vertices that is opposite the first vertex. The first edge vector and the second edge vector exclude the first vertex or the vertex opposite the first vertex. In step S520, the encoder may determine a correction variable based on the predicted position of the first vertex and an actual position of the first vertex. The correction variable represents a vector from the predicted position to the actual position of the first vertex. The correction variable may also be referred to as an offset. In step S525 the encoder may encode the first vertex using the correction variable. The encoder may encode the first vertex with an indication that the Hexagon prediction scheme was used to encode the first vertex. This enables a decoder that is tasked with decoding the vertex to know which prediction scheme to use.

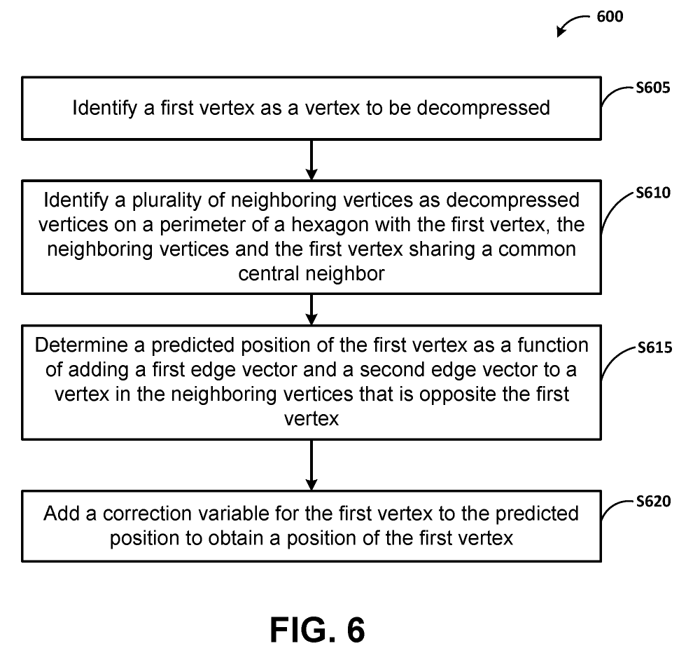

FIG. 6 is a block diagram of a method 600 for decompressing a next vertex within a geometric construct, according to at least one example implementation. As shown in FIG. 6, in step S605 a decoder may identify a first vertex as a vertex to be decompressed. In step S610 a decoder may identify a plurality of neighboring vertices as decompressed vertices on a perimeter of a hexagon with the first vertex, the neighboring vertices and the first vertex sharing a common central neighbor.

In step S615 a decoder may determine a predicted position of the first vertex as a function of adding a first edge vector and a second edge vector to a vertex in the neighboring vertices that is opposite the first vertex. The first edge vector and the second edge vector do not include the first vertex or the vertex opposite the first vertex. In step S620 the decoder may add a correction variable for the first vertex to the predicted position to obtain a decompressed position of the first vertex. The correction variable represents a vector from the predicted position to the actual position of the first vertex. The correction variable may also be referred to as an offset. This enables the decoder to arrive at the actual position of the first vertex using only the correction variable and the portion of the neighboring vertices.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system’s registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Although certain example computer-implemented methods, apparatuses and articles of manufacture have been described herein, the scope of coverage of this patent is not limited thereto. It is to be understood that terminology employed herein is for the purpose of describing particular aspects, and is not intended to be limiting. On the contrary, this patent covers all methods, apparatus and articles of manufacture fairly falling within the scope of the claims of this patent.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

The following paragraphs provide various examples of the implementations disclosed herein.

In one aspect, the disclosed implementations relate to a method for decompressing vertex data. The method comprises identifying a first vertex as a vertex to be decompressed and identifying a plurality of neighboring vertices as decompressed vertices. The method further comprises determining a predicted position of the first vertex as a function of adding a first edge vector and a second edge vector to a second vertex in the neighboring vertices, where the second vertex is opposite the first vertex. Finally, the method comprises adding a correction variable for the first vertex to the predicted position to obtain a decompressed position of the first vertex.

In another aspect, the plurality of neighboring vertices are on a perimeter of a hexagon with the first vertex.

In another aspect, the plurality of neighboring vertices and the first vertex share a common central neighbor.

In another aspect, the correction variable represents a vector from the predicted position to the decompressed position of the first vertex.

In another aspect, the method further comprises receiving geometric data including a triangular mesh.

In another aspect, the first edge vector and the second edge vector exclude the first vertex and the second vertex.

In one aspect, the disclosed implementations relate to a method for compressing vertex data. The method comprises identifying a first vertex as a vertex to be compressed and identifying a plurality of neighboring vertices as compressed vertices. The method further comprises determining a predicted position of the first vertex as a function of adding a first edge vector and a second edge vector to a second vertex in the neighboring vertices, the second vertex being opposite the first vertex. The method also comprises determining a correction variable for the first vertex based on the predicted position and an actual position of the first vertex, and compressing the first vertex using the correction variable.

In another aspect, the plurality of neighboring vertices identified during compression are on a perimeter of a hexagon with the first vertex.

In another aspect, the plurality of neighboring vertices identified during compression and the first vertex share a common central neighbor.

In another aspect, the first edge vector and the second edge vector exclude the first vertex and the second vertex.

In another aspect, the correction variable represents a vector from the predicted position to the actual position of the first vertex.

In another aspect, the method for compressing the first vertex further comprises receiving geometric data including a triangular mesh.

In one aspect, a computing device is provided, comprising at least a processor and a memory storing instructions. When executed by the processor, these instructions cause the computing device to perform operations including identifying a first vertex as a vertex to be decompressed and identifying a plurality of neighboring vertices as decompressed vertices. The operations further include determining a predicted position of the first vertex as a function of adding a first edge vector and a second edge vector to a second vertex in the plurality of neighboring vertices, where the second vertex is opposite the first vertex. The operations also include adding a correction variable for the first vertex to the predicted position to obtain a decompressed position of the first vertex.

In another aspect, for the computing device, the plurality of neighboring vertices are on a perimeter of a hexagon with the first vertex.

In another aspect, for the computing device, the plurality of neighboring vertices and the first vertex share a common central neighbor.

In another aspect, for the computing device, the first edge vector and the second edge vector exclude the first vertex and the second vertex.

In another aspect, for the computing device, the correction variable represents a vector from the predicted position to the decompressed position of the first vertex.

In another aspect, for the computing device, the operations of the computing device further comprise receiving geometric data including a triangular mesh.

In another aspect, for the computing device, the first vertex is a vertex in a geometric construct, the geometric construct including a triangular grid.

What is claimed is:

1. A method comprising:
identifying a first vertex as a vertex to be decompressed;
identifying a plurality of neighboring vertices as decompressed vertices;
determining a predicted position of the first vertex as a function of adding a first edge vector and a second edge vector to a second vertex in the plurality of neighboring vertices, the second vertex being opposite the first vertex; and
adding a correction variable for the first vertex to the predicted position to obtain a decompressed position of the first vertex.

2. The method of claim 1, wherein the plurality of neighboring vertices are on a perimeter of a hexagon with the first vertex.

3. The method of claim 2, wherein the plurality of neighboring vertices and the first vertex share a common central neighbor.

4. The method of claim 1, wherein the correction variable represents a vector from the predicted position to the decompressed position of the first vertex.

5. The method of claim 1, further comprising receiving geometric data including a triangular mesh.

6. The method of claim 1, wherein the first edge vector and the second edge vector exclude the first vertex and the second vertex.

7. The method of claim 1, wherein the first vertex is a vertex in a geometric construct, the geometric construct including a triangular mesh.

8. A method comprising:
identifying a first vertex as a vertex to be compressed;
identifying a plurality of neighboring vertices as compressed vertices;
determining a predicted position of the first vertex as a function of adding a first edge vector and a second edge vector to a second vertex in the plurality of neighboring vertices, the second vertex being opposite the first vertex;
determining a correction variable for the first vertex based on the predicted position and an actual position of the first vertex; and
compressing the first vertex using the correction variable.

9. The method of claim 8, wherein the plurality of neighboring vertices are on a perimeter of a hexagon with the first vertex.

10. The method of claim 9, wherein the plurality of neighboring vertices and the first vertex share a common central neighbor.

11. The method of claim 8, wherein the first edge vector and the second edge vector exclude the first vertex and the second vertex.

12. The method of claim 8, wherein the correction variable represents a vector from the predicted position to the actual position of the first vertex.

13. The method of claim 8, further comprising determining that a norm of edge vectors formed by the plurality of neighboring vertices exceeds a predetermined threshold prior to determining the predicted position of the first vertex.

14. A computing device comprising:
at least a processor; and
a memory storing instructions that, when executed by the processor, cause the computing device to perform operations including:
identifying a first vertex as a vertex to be decompressed;
identifying a plurality of neighboring vertices as decompressed vertices;
determining a predicted position of the first vertex as a function of adding a first edge vector and a second edge vector to a second vertex in the plurality of neighboring vertices, the second vertex being opposite the first vertex; and
adding a correction variable for the first vertex to the predicted position to obtain a decompressed position of the first vertex.

15. The computing device of claim 14, wherein the plurality of neighboring vertices are on a perimeter of a hexagon with the first vertex.

16. The computing device of claim 15, wherein the plurality of neighboring vertices and the first vertex share a common central neighbor.

17. The computing device of claim 14, wherein the first edge vector and the second edge vector exclude the first vertex and the second vertex.

18. The computing device of claim 14, wherein the correction variable represents a vector from the predicted position to the decompressed position of the first vertex.

19. The computing device of claim 14, wherein the operations further comprise receiving geometric data including a triangular mesh.

20. The computing device of claim 14, wherein the first vertex is a vertex in a geometric construct, the geometric construct including a triangular mesh.
